(19) United States
(12) Patent Application Publication
(10) Pub. No.: US 2004/0137143 A1
(43) Pub. Date: Jul. 15, 2004

(54) Forming method using thermal transfer printing sheet

(75) Inventor: Sook Hee Chung, Suwon-Si (KR)

Correspondence Address: MERCHANT & GOULD PC, P.O. BOX 2903, MINNEAPOLIS, MN, 55402-0903, US

(73) Assignee: KOREA CHEMICAL CO., LTD., Paju-Si (KR)

(21) Appl. No.: 10/634,230

(22) Filed: Aug. 5, 2003

(30) Foreign Application Priority Data
Jan. 9, 2003 (KR) 10-2003-0001389

(51) Int. Cl. B05D 5/00

(52) U.S. Cl. 427/146; 156/230; 427/256

(57) ABSTRACT

The present invention relates to a forming method using a thermal transfer printing sheet which is capable of implementing a 3D pattern through a method of forming a protruded surface using a thermal conduction difference of each portion in such a manner that a partial deposition thermal transfer printing sheet is printed on a surface of a base material of a plastic related thing, or a gold silver thin film is partially printed by a carving roller, and then the printed surface is heated to a certain temperature, so that the surface is divided into a heat blocked portion and a heat absorbed portion. In the forming method using a partial deposition thermal transfer printing sheet or a gold silver thermal transfer printing sheet according to the present invention, a thermal transfer printing sheet is dry=printed using only a heat and pressure, and a protruded surface is easily formed through a thermal diffusion process. It is possible to form various natural protruded surfaces. A work process is simple, and an excellent 3D pattern and economical product are implemented. In addition, it is possible to form various natural 3D patterns without any limit in the size of the base material or the type of the roller.

### BACKGROUND OF THE INVENTION

1. Field of the Invention

The present invention relates to a forming method using a thermal transfer printing sheet which is capable of fabricating a formed product having a protruded surface formed using a thermal conduction difference of each portion in such a manner that a partial deposition thermal transfer printing sheet is printed on a surface of a base material of a plastic related thing, or a gold silver thin film is partially printed by a carving roller, and then the printed surface is heated to a certain temperature, so that the surface is divided into a heat blocked portion and a heat absorbed portion.

2. Description of the Background Art

Generally, in a process line for fabricating a picture frame or an architecture interior material using a transfer printing film, when fabricating a product having a special protruded pattern (design) effect, a thermal transfer printing sheet is printed on a corresponding object in the conventional art, and a heat is applied to the surface. Thereafter, a carving roll on which a desired pattern is carved is pressurized for a certain period, so that a protruded pattern is implemented on a surface of an object in the same shape as the pattern carved on the carving roll.

However, in a method in which a protruded pattern is formed on a printed surface using a carving roll after a thermal transfer printing is performed, since a carving roll having a corresponding carved pattern is additionally fabricated based on a size and pattern of a base material on which a pattern is formed, the fabrication cost of a patterned product is increased.

In addition, in the product which has a protruded pattern effect using a carving roll, the pattern is divided into a protruded portion and a depressed portion, so that a boundary therebetween is not clear. In addition, a finished product fabricated using a carving roll has a simple pattern in a protruded surface due to a limited shape of a carving roll by which a certain pattern is formed, and it is impossible to implement various natural patterns in a protruded surface. Therefore, in a conventional pattern forming method using a carving roll, there is a limit for forming various patterns.

### SUMMARY OF THE INVENTION

Accordingly, it is an object of the present invention to overcome the problems encountered in the conventional art.

It is another object of the present invention to provide a forming method using a thermal transfer printing sheet which is capable of implementing various natural 3D patterns by forming various protruded surfaces using a partial thermal disconnection effect.

It is further another object of the present invention to provide a forming method using a thermal transfer printing sheet which is capable of implementing a simple and efficient fabrication process and decreasing a fabrication cost of a product in such a manner that a 3D protruded pattern surface is simply formed using only a heating apparatus.

To achieve the above objects, there is provided a forming method using a thermal transfer printing sheet, comprising the steps of a step S100 for forming a base material 10 using a resin, a step S300 for printing a partial deposition thermal transfer printing sheet 21 on a surface of the formed base material 10 or partially printing a gold silver thermal transfer printing sheet 21 on a surface of the same, a step S400 for heating a surface of the printed base material 10 and depressing a part of a conduction film 24 on the base material 10 and a part of the lower base material 10 based on a heat melting method, and a step S500 for cooling the base material 10.

In addition, the forming method using a thermal transfer printing sheet further includes a step for transferring the formed base material. At this time, the step S300 is implemented based on an interworking with the transfer of the base material.

### BRIEF DESCRIPTION OF THE DRAWINGS

The present invention will become better understood with reference to the accompanying drawings which are given only by way of illustration and thus are not limitative of the present invention, wherein;

FIG. 1 is a cross sectional view schematically illustrating the construction before and after a thermal melting of a base material in which a thermal film is formed according to an embodiment of the present invention;

FIG. 2 is a flow chart illustrating a forming method using a thermal transfer printing sheet according to an embodiment of the present invention;

FIG. 3 is a view illustrating a schematic process construction concerning a forming method using a thermal transfer printing sheet according to an embodiment of the present invention;

FIG. 4A is a schematic example view illustrating a plan model of a heater of FIG. 3;

FIG. 4B is a schematic example view illustrating a concave model of a heater of FIG. 3; and

FIG. 4C is a schematic example view illustrating a convex model of a heater of FIG. 3.

### DETAILED DESCRIPTION OF THE PREFERRED EMBODIMENTS

The forming method using a thermal transfer printing sheet according to the present invention will be described.

First, a partial deposition thermal transfer printing sheet disclosed in an embodiment of the present invention represents that a metallic layer is partially formed on a thermal transfer printing target member in such a manner that a metallic layer is partially deposited on a thermal transfer printing sheet for printing on a thermal transfer printing target member, and a partial transfer printing of a gold silver thermal transfer printing sheet represents that a gold silver layer on a gold silver thermal transfer printing sheet is partially printed on a transfer printing target member.

In the present invention, in order for a printed metallic conduction film to be partially formed on a base material, a transfer printing is performed using a partial deposition thermal transfer printing sheet or a gold silver thermal transfer printing sheet is partially printed using a carving roller. Thereafter, when a heat is applied to a surface of a base material on which a printed conduction film is formed, a part of a base material on which a metallic conduction film is printed, is disconnected from heat, and the other portions of a base member in which a metallic conduction film is not printed, are not disconnected from heat. Therefore, the other portions of the base material in which the heat is not disconnected are depressed by a heat melting for thereby forming a protruded surface.

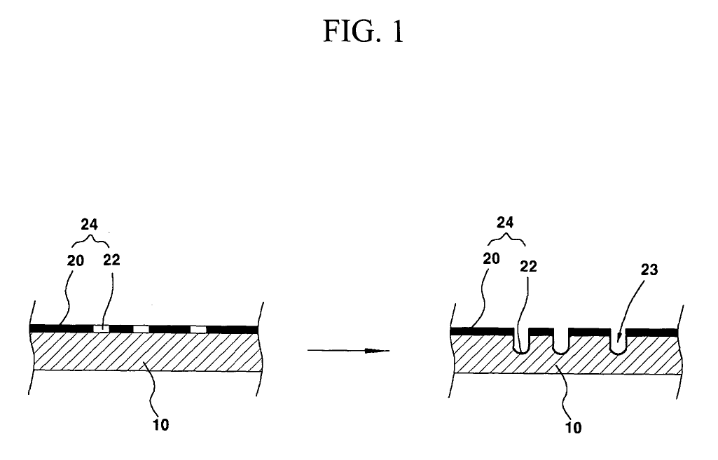

FIG. 1 is a cross sectional view schematically illustrating the construction before and after a thermal melting of a base material in which a thermal film is formed according to an embodiment of the present invention.

As shown in FIG. 1, when a conduction film 24 printed on a surface of a base material 10 is heated by a thermal transfer printing sheet 21, an ink conduction film 22 among the printed conduction film 24 is thermally melted together with the base material 10 for thereby forming a depressed portion. The part in which heat is not applied is protruded, so that a protruded surface is formed. Here, an ink of the ink conduction film 23 is filled in the depressed portion 23. The ink may be further coated thereon.

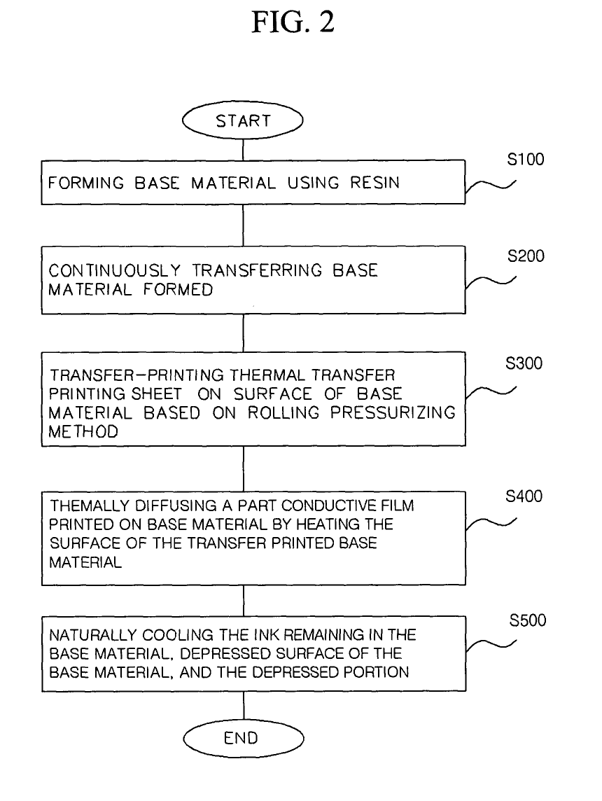

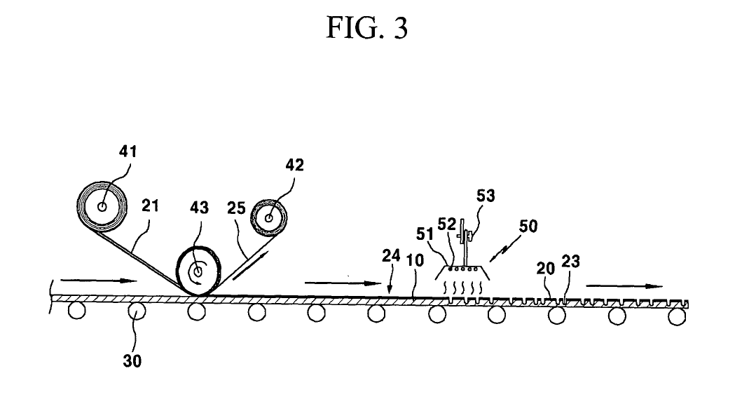

FIG. 2 is a flow chart illustrating a forming method using a thermal transfer printing sheet according to an embodiment of the present invention, and FIG. 3 is a view illustrating a schematic process construction concerning a forming method using a thermal transfer printing sheet according to an embodiment of the present invention.

In the forming method using the thermal transfer printing sheet 21 according to an embodiment of the present invention, there are provided a feeding unit for feeding the base material 10 for thereby implementing a continuous process like a conveyor type, a transfer printing unit for printing the thermal transfer printing sheet 21 on the base material 10, a synthetic rubber roll or carving roll for dry-attaching the thermal transfer printing sheet 21, and a heating unit that the transfer conduction film 24 provides a heat to the transfer finished base material 10 at a certain distance.

As shown in FIGS. 2 and 3, in the forming method using the thermal transfer printing sheet 21 according to the present invention, a base material 10 is formed using a resin (S100).

In order to form the base material 10, a polystyrene in a plastic series resin or a resin of a polyvinylchloride series is inputted into an extruder as a source material, and the inputted source material is heat-melted to a temperature of 130˜200° C. Thereafter, the base material 10 is extruded in various shapes such as a rod shape, a forming form or a plate shape. FIG. 3 shows a plate type base material according to an example of the present invention.

As a source material of the base material 10, an ABS or HIPS may be used instead of a resin of a polystyrene or polyvinylchloride series.

The size and length of the base material 10 may be determined based on the amount of inputted source material. A certain coloring agent or dye agent may be used for implementing a desired color. A foaming agent may be provided for implementing a strength adjustment.

Next, the formed base material 10 is printed (S200). The formed base material 10 is placed on a conveyor 30 and is continuously printed.

The partial deposition thermal transfer printing sheet 21 is printed on a surface of the base material 10 based on an interworking with the transfer of the base material or the gold silver thermal transfer printing sheet 21 is partially printed thereon (S300).

The thermal transfer printing sheet 21 is continuously printed on a surface of the base material 10 based on an interworking with a feeding speed of the base material 10, and the printing operation is performed based on a dry diffusion transfer printing method in which a certain pressure and heat are provided. Namely, when a first roller 41 is rotated, the surface of the thermal transfer printing sheet 21 contacts with the base material 10, and a pressure of about 100˜300 kg/m² is vertically applied by the roller 43 including the heating unit at a temperature of 130˜200° C. Therefore, a stacked conduction film of the thermal transfer printing sheet 21 is printed on a surface of the base material 10. After the printing is performed, the film 25 that a stacked conduction film is removed from the thermal transfer printing sheet 21 is continuously rolled onto a second roller 42.

In the case that the partial deposition thermal transfer printing sheet is used, a pressurizing rubber roller is used for the roller 43, and in the case that the gold silver thermal transfer printing sheet is used, the carving roller is used.

A metallic conduction film 20 is partially formed on the film 25 of the thermal transfer printing sheet 21. An ink conduction film 22 having a certain color is formed partially. The thusly formed pattern corresponds to a pattern formed on the partial deposition thermal transfer printing sheet 21 or a pattern formed in such a manner that the gold silver conduction layer of the gold silver thermal transfer printing sheet 21 is partially formed on the base material 10.

The above pattern may be formed in various shapes. For example, there are a simply repeated geometric pattern for example a check pattern, water drop pattern, etc., a character pattern for example, Korean, English, Chinese character, etc., a graphic for example a circular shape, triangle shape, rectangular shape, straight line shape, etc., an image for example a tree, person, landscape, abstraction, Korean type painting, oriental painting, etc., and a combination of the above.

The surface of the printed base material 10 is heated, and a part of the printed conduction film 24 and a part of the lower base material 10 are depressed by the thermal melting method (S400).

The heating unit 50 installed on the conveyor 30 is used for a heating device.

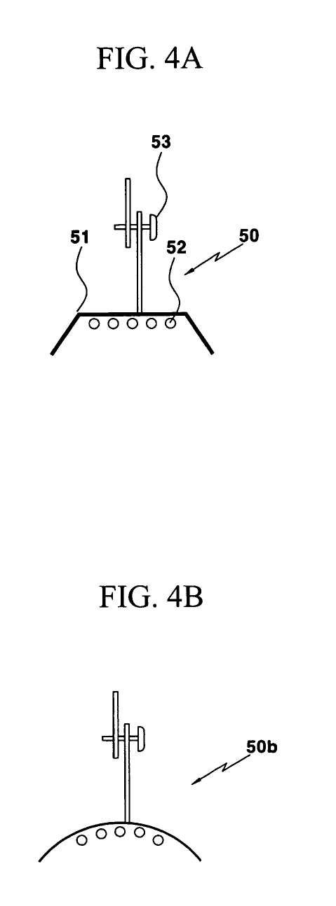

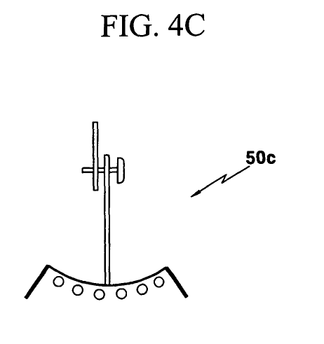

FIG. 4 is an example view illustrating the heating unit of FIG. 3.

As shown in FIG. 4, the heating unit 50 is freely movable and is installed in an outer side of the conveyor. The heating unit 50 includes a heat reflection plate 51 for enhancing a heating performance and a heat radiating filament 52 installed in an inner side of the heat reflection plate 51. The printing completed base material 10 which is continuously transferred by the conveyor 30 is heated to a temperature of about 130˜200° C.

The time of heating by the heating unit 50 is about 3˜5 seconds. At this time, since the heat is disconnected from the metallic conduction film 20 among the printed conduction film 24, and the lower base material 10 maintains an original shape, and the heat is not disconnected to the ink conduction film 22 among the printed conduction film 24, the ink conduction film 22 and the lower base material 10 are heat-melted for thereby forming a depression portion 23. A certain protruded surface corresponding to the pattern of the partial deposition thermal transfer printing sheet 21 or the pattern that the gold silver thermal transfer printing sheet 21 partially printed using the carving roller is formed in the base material 10 based on a difference between the heated and melted portion and the non-melted portion.

At this time, a certain color of the ink conduction film 22, for example, a white color, blue color, gold color, silver color, etc., is printed on the depressed portion 23 for thereby implementing a 3D pattern which has various colors.

In addition, the heating unit 50 is positioned in a portion straightly distanced by about 5˜15 cm from the heat transfer printing sheet 21. This straight line distance may be adjusted based on the pattern of the base material and the kinds of the plastic material which forms the base material 10.

FIG. 4A is a schematic example view illustrating a plan model of a heater of FIG. 3, FIG. 4B is a schematic example view illustrating a concave model of a heater of FIG. 3, and FIG. 4C is a schematic example view illustrating a convex model of a heater of FIG. 3.

As shown in FIGS. 4A, 4B and 4C, the heating unit 50 may be modified into various constructions. For example, the heating unit 50 may be classified into a plane type 50a, a concave type 50b, and a convex type 50c. The above types may be selected based on the type of the base material 10.

Therefore, the heating unit 50 may be freely selected based on the size of the base material 10, the surface type of the printed conduction film 24 such as the plane surface, concave surface, convex surface, etc. or the depth of the protruded surface.

In addition, a distance adjusting screw 53 is provided in the other side of each heating unit 50 for adjusting the interval between the printing completed base material 10 and the heating unit 50 for thereby freely adjusting the heating temperature and the heating area.

Finally, as the base material 10 is cooled, the 3D protruded surface pattern is implemented using the thermal transfer printing sheet 21 (S500).

The base material 10 having a protruded surface is continuously transferred by the conveyor 30. Here, the base material 10, the surface of the depressed portion 23 of the base material 10, and the ink remaining in the depressed portion 23 are naturally dried, but a certain unit for cooling the same may be additionally provided.

As described above, in the forming method using the partial thermal transfer printing sheet 21 of the gold silver thermal transfer printing sheet 21 is easily capable of forming a protruded surface through the thermal melting process after the thermal transfer printing sheet 21 is dry-printed using only the heat and pressure. In addition, it is possible to implement various natural protruded surfaces. The process is simplified. The formed 3D pattern is excellent. A desired economical advantage is obtained. In addition, in the present invention, it is possible to form various natural 3D patterns without any limit in the size of the base material or the construction of the carving roll.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. A forming method using a thermal transfer printing sheet, comprising the steps of:
a step S100 for forming a base material 10 using a resin;
a step S300 for printing a partial deposition thermal transfer printing sheet 21 on a surface of the formed base material 10 or partially printing a gold silver thermal transfer printing sheet 21 on a surface of the same;
a step S400 for heating a surface of the printed base material 10 and depressing a part of a conduction film 24 on the base material 10 and a part of the lower base material 10 based on a heat melting method; and
a step S500 for cooling the base material 10.

2. The method of claim 1, wherein said step S100 is implemented using a resin of a polystyrene series or a resin of a polyvinylchloride series as a source material of the base material.

3. The method of claim 1, wherein in said step S300, the thermal transfer printing sheet 21 is printed on the base material 10 based on a dry diffusion method.

4. The method of claim 1, wherein in said step S400, a surface of the base material 10 is heated to a temperature of 130˜200° C.

5. The method of claim 1, further comprising a step S200 in which the formed base material 10 is transferred.

6. The method of claim 5, wherein said step S100 is implemented using a resin of a polystyrene series or a resin of a polyvinylchloride series as a source material of the base material.

7. The method of claim 5, wherein in said step S200, the base material 10 is continuously transferred by a conveyor.

8. The method of claim 5, wherein in said step S300, the thermal transfer printing sheet 21 is printed on the base material 10 based on a dry diffusion method.

9. The method of claim 5, wherein said step S300 is implemented based on an interworking with the transfer of the base material 10.

10. The method of claim 5, wherein said step S300 is implemented using a resin of a polystyrene series or a resin of a polyvinylchloride series as a source material of the base material.

11. The method of claim 10, wherein said step S300 is implemented using a resin of a polystyrene series or a resin of a polyvinylchloride series as a source material of the base material.

12. The method of claim 10, wherein in said step S200, the base material 10 is continuously transferred by a conveyor.

13. The method of claim 10, wherein in said step S300, the thermal transfer printing sheet 21 is printed on the base material 10 based on a dry diffusion method.

14. The method of claim 10, wherein in said step S400, a surface of the base material 10 is heated to a temperature of 130˜200° C.
